(19) United States
(12) Patent Application Publication
(10) Pub. No.: US 2011/0302170 A1
(43) Pub. Date: Dec. 8, 2011

(54) UTILIZING SEARCH POLICIES TO DETERMINE SEARCH RESULTS

(75) Inventor: VLADIMIR HOLOSTOV, Redmond, WA (US)

(73) Assignee: MICROSOFT CORPORATION, Redmond, WA (US)

(21) Appl. No.: 12/793,415

(22) Filed: Jun. 3, 2010

(51) Int. Cl. G06F 17/30

(52) U.S. Cl. 707/740; 707/759; 707/E17.014; 707/E17.046

(57) ABSTRACT

Methods for factoring search and browse policies and content preferences into Web search results are provided. Such search and browse policies and/or content preferences generally are provided by a parent, an employer, or other company representative and specify to whom they apply. Upon receiving a search query from a particular user, it is determined whether one or more search and browse policies and/or content preferences apply to the received search query. Upon determining that one or more search and browse policies and/or content preferences apply to the received search query, at least one of the received search query and any search results determined as satisfying the search query are analyzed in accordance with the one or more applicable search and browse policies and/or content preferences applying to the user. Any necessary modifications are made to the search results before the results are presented to the user.

### BACKGROUND

Contemporary enterprise Web filtering solutions allow administrators to block certain sites or redirect users to different sites, usually intranet resources detailing a company's browsing policy. Not only is such blocking off-putting to the users receiving the blocking message, it is limiting with respect to allowable actions on the part of those administering the search and browse policies.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-readable media for, among other things, factoring search and browse policies and content preferences into Web search results. Such search and browse policies and/or content preferences may be provided, for instance, by an employer or other company representative and specify to whom they apply, e.g., employees (all or a subset thereof) and/or other persons associated with the relevant company, user groups, computing devices (or groups thereof), networks, and the like. Upon receiving a search query, it is determined whether one or more search and browse policies and/or content preferences apply to the query. If it is determined that one or more search and browse policies and/or content preferences apply to the query, at least one of the received search query and any search results determined as satisfying the search query are analyzed in accordance with the one or more applicable search and browse policies and/or content preferences. Any necessary modifications are made to the search results before the results are presented. Thus, the results of the input search query that are presented are in compliance with any applicable browse and search policies and/or content preferences.

### BRIEF DESCRIPTION OF THE DRAWINGS

The present invention is illustrated by way of example and not limited in the accompanying figures in which like reference numerals indicate similar elements and in which:

FIG. 1 is a block diagram of an exemplary computing environment suitable for use in implementing embodiments of the present invention;

FIG. 2 is a block diagram of an exemplary computing system in which embodiments of the invention may be employed;

FIG. 3 is a flow diagram showing a method for utilizing search and browse policies and/or content preferences to determine search results, in accordance with an embodiment of the present invention; and

FIG. 4 is a flow diagram showing a method for utilizing search and browse policies and/or content preferences to determine search results, in accordance with another embodiment of the present invention.

### DETAILED DESCRIPTION

The subject matter of the present invention is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to factoring search and browse policies and content preferences into Web search results. Such search and browse policies and/or content preferences may be provided, for instance, by an employer or other company representative and specify to whom they apply, e.g., employees (all or a subset thereof) and/or other persons associated with the relevant company, user groups, computing devices (or groups thereof), networks, and the like. Such search and browse policies and/or content preferences may also be configured and provided by a user. For instance, a search and browse policy and/or content preference may take the form of a parental control configured by one user to be applied with respect to one or more users of a home computing device. Any and all such variations, and any combination thereof, are contemplated to be within the scope of embodiments of the present invention.

Upon receiving a search query, it is determined whether one or more search and browse policies and/or content preferences apply to the query. If it is determined that one or more search and browse policies and/or content preferences apply to the query, at least one of the received search query and any search results determined as satisfying the search query are analyzed in accordance with the one or more applicable search and browse policies and/or content preferences. Any necessary modifications are made to the search results before the results are presented. Thus, the results of the input search query that are presented are in compliance with any applicable browse and search policies and/or content preferences.

Accordingly, one embodiment of the present invention is directed to one or more computer-readable storage media storing computer-useable instructions that, when used by one or more computing devices, cause the one or more computing devices to perform a method for utilizing search policies to determine search results. The method comprises receiving a search query input by a user, determining that at least one search policy applies to the received search query, modifying a plurality of search results that satisfies the received search query in accordance with the at least one search policy, and outputting the modified plurality of search results, e.g., for presentation in association with the user's computing device.

Another embodiment of the present invention is directed to a search result modification system. The system comprises a computing device associated with one or more processors and one or more computer-readable storage media; a data store coupled with the computing device; and a search policy identification engine that receives a search query input by a user and a plurality of search results that satisfies the received search query, identifies at least one search policy associated with the received search query, modifies the plurality of search results in accordance with the at least one search policy, and outputs the modified plurality of search results for presentation.

In yet another embodiment, the present invention is directed to one or more computer-readable storage media storing computer-useable instructions that, when used by one or more computing devices, cause the one or more computing devices to perform a method for utilizing search policies to determine search results. The method comprises receiving a search query input by a user, identifying at least one search policy that applies to the received search query, receiving a plurality of search results that satisfy the received search query, modifying the plurality of search results that satisfy the received search query in accordance with the at least one search policy, and outputting the modified plurality of search results.

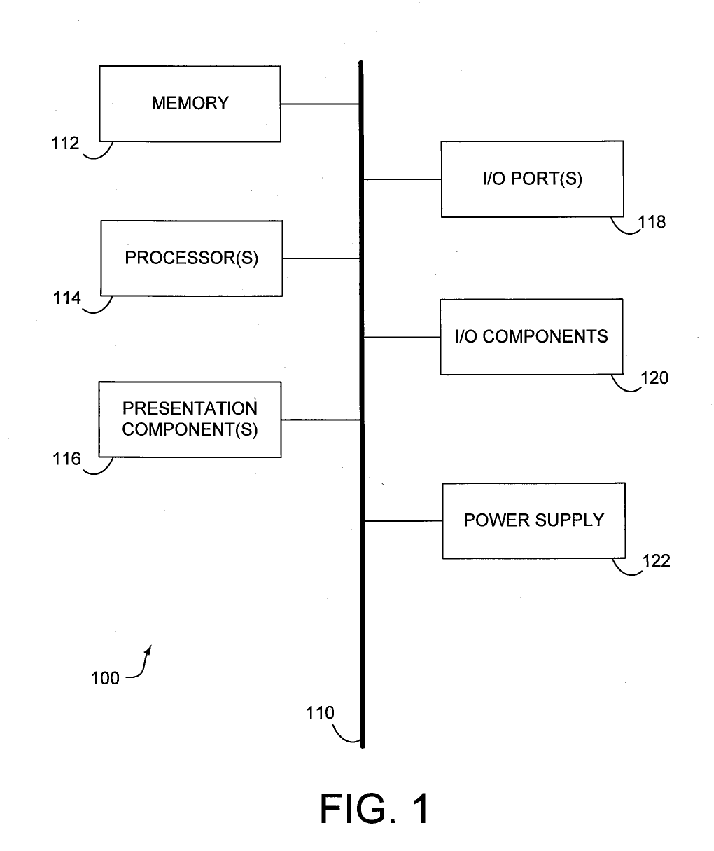

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With reference to FIG. 1, the computing device 100 includes a bus 110 that directly or indirectly couples the following devices: a memory 112, one or more processors 114, one or more presentation components 116, input/output ports 118, input/output components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventor hereof recognizes that such is the nature of the art, and reiterates that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media can be any available media that can be accessed by the computing device 100 and includes both volatile and nonvolatile media, removable and non-removable media implemented in any method or technology for storage of information such as computer-readable instructions, data structures, program modules or other data. Computer-readable media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Combinations of any of the above should also be included within the scope of computer-readable media.

The memory 112 includes computer-storage media in the form of volatile and/or nonvolatile memory. The memory may be removable, nonremovable, or a combination thereof. Exemplary hardware devices include solid-state memory, hard drives, optical-disc drives, etc. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative components include a microphone, joystick, game pad, satellite dish, scanner, printer, wireless device, and the like.

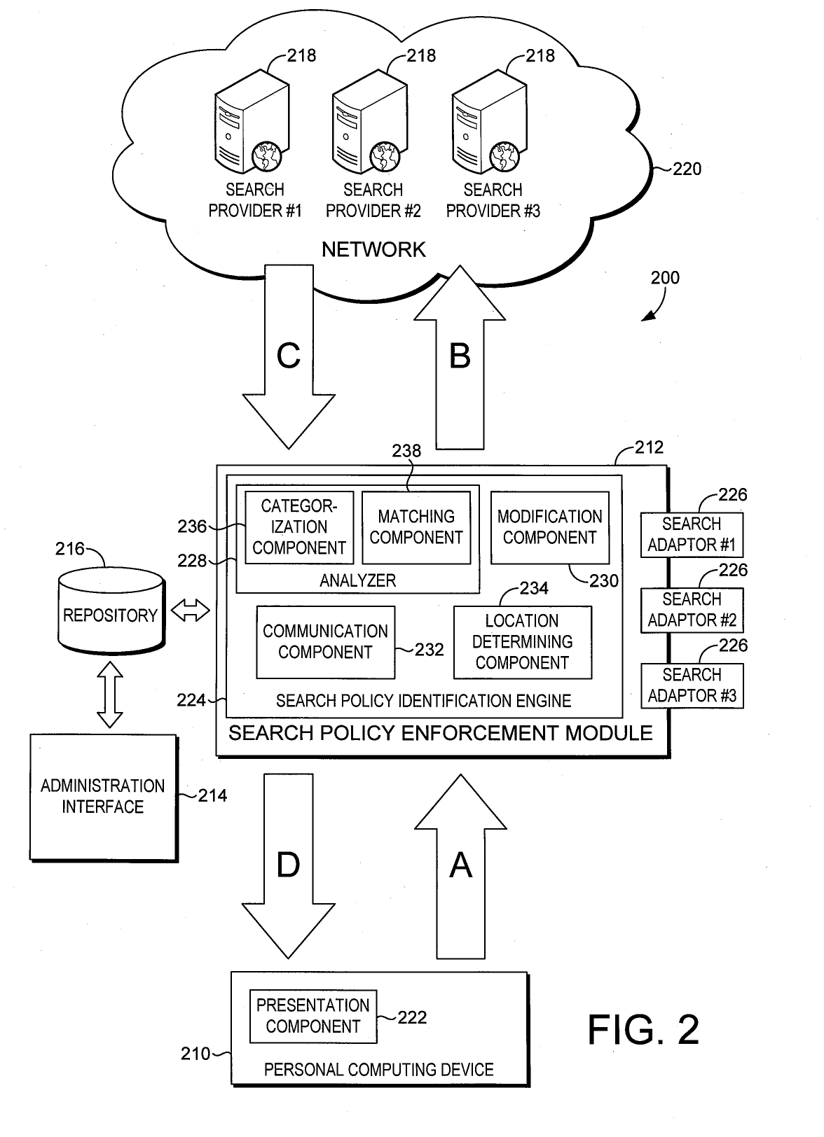

As indicated previously, embodiments of the present invention are directed to factoring search and browse policies and/or content preferences into Web search results. Referring now to FIG. 2, a block diagram is provided illustrating an exemplary computing system 200 in which embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the computing system 200 generally includes a personal computing device 210, a search policy enforcement module 212, an administrator interface 214, a data repository 216 and a plurality of search providers 218. The personal computing device 210 may include any type of computing device, such as computing device 100 described with reference to FIG. 1, for example. The search policy enforcement module 212 may take the form of a dedicated device for performing the functions described below; may be integrated into, e.g., the personal computing device 210, a network access device, a search engine, or the like; or any combination thereof. The administration interface 214 may take the form of a dedicated device for administration, in which case such device may include any type of computing device (e.g., computing device 100 described herein above), may be an Internet-based service, may be provided as a module inside a search engine, or any combination thereof. The components of the computing system 200 may communicate with each other via a network (e.g., network 220), which may include, without limitation, one or more local area networks (LANs) and/or wide area networks (WANs). Such networking environments are commonplace in offices, enterprise-wide computer networks, intranets and the Internet. It should be understood that any number of client devices, search policy enforcement modules and administration interfaces may be employed in the computing system 200 within the scope of embodiments of the present invention. Each may comprise a single device/interface or multiple devices/interfaces cooperating in a distributed environment. For instance, the search policy enforcement module 212 may comprise multiple devices and/or modules arranged in a distributed environment that collectively provide the functionality of the search policy enforcement module 212 described herein. Additionally, other components/modules not shown may also be included within the computing system 200.

In some embodiments, one or more of the illustrated components/modules may be implemented as stand-alone applications. In other embodiments, one or more of the illustrated components/modules may be implemented via the personal computing device 210, as an Internet-based service, or as a module inside a search engine. It will be understood by those of ordinary skill in the art that the components/modules illustrated in FIG. 2 are exemplary in nature and in number and should not be construed as limiting. Any number of components/modules may be employed to achieve the desired functionality within the scope of embodiments hereof. Further, components/modules may be located on any number of servers or client computing devices. By way of example only, the search policy identification engine 224 might reside on a server, cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

Generally, the computing system 200 illustrates an environment in which search and browse policies and/or content preferences may be factored into Web search results. As will be described in further detail below, embodiments of the present invention provide employers, parents, educators, administrators and the like to cause search queries input by member- (e.g., employee-) users, and/or the results thereof, to be filtered in accordance with query-specific search and browse policies and/or content preferences such that the results that are presented to the member-user in response to the input query are in compliance therewith.

The administration interface 214 is configured to receive input, e.g., from an employer, parent, educator, administrator and/or other company representative specifying one or more search and browse policies and/or content preferences to be applied to search queries input by persons associated therewith and/or search results identified for search queries input by such persons. Such search and browse policies and/or content preferences are generally pre-configured by the employer, parent, educator, administration and/or other company representative and specify one or more rules for processing search queries and/or search query results. Generally, a particular input search and browse policy and/or content preference is associated with a particular company, organization, or the like. As such, the administration interface 214 is further configured to receive input of identifiers specifying to whom such policies and preferences apply, e.g., employees (all or a subset thereof) and/or other persons associated with the relevant company or organization, user groups, computing devices (or groups thereof), networks, and the like. Once input, such information may be stored in association with the data repository 216, as more fully described below.

The data repository 216 is configured to store information associated with search and browse policies, content preferences, user identifiers, content items (e.g., search results), content for enhancing search results, and the like. In various embodiments, such information may include, without limitation, user profile data, profile data associated with a group of users, employer and/or other company search and browse policies and/or content preferences, user and group identifiers, content to be utilized for enhancing search results, links to any of the above, and the like. In embodiments, the data repository 216 is configured to be searchable for one or more of the items stored in association therewith. It will be understood and appreciated by those of ordinary skill in the art that the information stored in association with the data repository 216 may be configurable and may include any information relevant to one or more search and browse policies, content preferences, user identifiers, content items, search-result-enhancement content and/or the like. The content and volume of such information are not intended to limit the scope of embodiments of the present invention in any way. Further, though illustrated as a single, independent component, the data repository 216 may, in fact, be a plurality of storage devices, for instance a database cluster, portions of which may reside in association with the search policy enforcement module 212, the personal computing device 210, another external computing device (not shown), and/or any combination thereof.

With continued reference to FIG. 2, the client device 210 includes a presentation component 222 configured for presenting a search query input region, for instance, upon the user accessing an interface associated with a particular search provider 218 (e.g., any of search provider #1, search provider #2, or search provider #3). Upon presentation of the search query input region (not shown), the user may input one or more search query terms, as more fully described below.

The presentation component 222 is further configured to present the results of input search queries in association with a display screen (not shown) of the personal computing device 210, the results being in compliance with one or more query-specific search and browse policies and/or content preferences. While search results are described as being provided and presented, it is straightforward for the computing system 200 to provide a link or other reference by which the user may retrieve the relevant result(s). Note that the link need not be followed by a conventional browser; for example, an application residing on or accessed by the personal computing device 210 can follow the link, obtain the search result(s), and insert a representation of the search result(s) into its output. Further, the functionality described herein as being performed by the presentation component 222 may be performed by a web browser or any other application capable of rendering web content. Any and all such variations, and any combination thereof, are contemplated to be within the scope of embodiments of the present invention.

Generally, the search query results presented in association with the personal computing device 210 are modified and/or enhanced search results. That is, the results are modified and/or enhanced relative to how they would be identified and presented absent the computing system 200 of the present invention. In the embodiment shown in FIG. 2 wherein one or more query-specific search and browse policies and/or content preferences are applied to a search query (and/or the results thereof) by a search policy enforcement module 212, the results are modified and/or enhanced relative to how they are received from the search provider (as more fully described below with reference to modification component 230 of the search policy identification engine 224). Modified search results in accordance with the computing system 200, by way of example, are modified in the order to which they are presented to the user, the order in which they are received from the search provider being different from the order in which they are presented to the user. Enhanced search results in accordance with the computing system 200, by way of example, are enhanced with content in addition to the search results themselves, that is, are enhanced with content in addition to that which is received from the search provider.

The search policy enforcement module 212 of FIG. 2 includes a search policy identification engine 224 and one or more search adaptors 226. Each of the search adaptors 226 is configured to allow the search policy enforcement module 212 to modify input search queries so that such search queries may be understood by an associated search provider 218. Similarly, each of the search adaptors 226 is configured to allow the search policy enforcement module 212 to process and modify search query results such that the results may be understood by the search policy enforcement module 212 and/or the personal computing device 210. Each of the search adaptors 226 is associated with a particular search provider(s) 218 and is configured to take into account any specifics associated with that particular search provider(s) 218. Accordingly, the search policy enforcement module 212 is able to apply the search and browse policies and/or content preferences to search results returned by search providers for which the system 200 has search adaptors 226. The embodiment of FIG. 2 includes three search providers (Search Provider #1, Search Provider #2, and Search Provider #3) and three associated search adaptors (Search Adaptor #1 associated with Search Provider #1, Search Adaptor #2 associated with Search Provider #2, and Search Adaptor #3 associated with Search Provider #3). Such embodiment is merely illustrative and should not be construed as limiting of embodiments of the present invention in any way.

The search policy identification engine 224 is configured to identify search and browse policies and/or content preferences that are relevant to search queries input by particular users and to apply any identified policies and/or preferences to identified search results prior to those results being presented to the user (e.g., in association with the personal computing device 210). The search policy identification engine 224 includes an analyzer component 228, a modification component 230, a communication component 232 and a location-determining component 234. The modification component 230 is configured to apply matching search and browse policies and/or content preferences to search results identified by one or more search engines 218 for an input search query. Thus, the modification component 230 is configured to parse and modify search query results in accordance with matching personal and/or company search and browse policies and/or content preferences. Such modification may include, by way of example only, changing the order in which search results are presented to the user relative to the order specified by the search engine, removing particular search results as originating with a source a particular applicable search and browse policy prohibits, and the like. The modification component 230 is further configured to enhance search query results by embedding or otherwise introducing additional content into search query results in accordance with a matching personal or company search and browse policy and/or content preference.

The communication component 232 is configured to communicate adapted search queries to affiliated search provider(s) 218 and to communicate identified search results to the search policy enforcement module 212, for instance, via the network 220. Thus, in the embodiment of FIG. 2, the communication component 232 permits interaction between the search policy enforcement module 212 (generally through a corporate firewall) and one or more search providers 218.

The location-determining component 234 is configured to assist the search policy enforcement module 212 in having an awareness of the user's location. The user's location may be acquired or determined in a variety of ways including, but not limited to, using the user's IP address, user profile information, or WLAN station to which the user is connected. Additionally, the search policy enforcement module 212 may use external services to determine the location of the user. Any and all such variations, and any combination thereof, are contemplated to be within the scope of embodiments of the present invention. Such user-location may be utilized to identify persons to whom a particular policy or preference applies and/or may be utilized to enhance search results presented to the user. For instance, if a user is determined by the location-determining component 234 to be on the fifth floor of the building, the search results may be configured to include a floor map and/or directions to the nearest first aid station, or the like. Any and all such variations, and any combination thereof, are contemplated to be within the scope of embodiments of the present invention.

The analyzer component 228 of the search policy enforcement module 212 is configured to locate one or more search and/or browse policies and/or content preferences that apply to a received a search query. The analyzer component 228 includes a categorization component 236 and a matching component 238. The categorization component 236 is configured to parse and categorize one or both of input search queries and results of input search queries. Based upon such categorizations, one or more search and browse policies and/or content preferences may be determined to apply and, as such, categorization may facilitate appropriate policy and/or preference application.

The matching component 238 is configured to match search queries and/or search results (categorized or uncategorized, as appropriate) with pre-configured search and browse policies and/or content preferences. Generally, such matching is query-specific, that is, only applied to queries received from users, user groups, computing devices (or groups thereof), networks, and the like, specified within, or in conjunction with, the relevant search and/or browse policy and/or content preference.

In application, in the embodiment illustrated in FIG. 2, a user inputs a search query using the personal computing device 210. The input search query is forwarded through a network (not shown) to the search policy enforcement module 212 (illustrated as data path A). The search adaptor(s) 226 are utilized to forward the search query to the search provider(s) 218 via network 220 (illustrated as data path B) where appropriate search results are identified. The identified search results are forwarded to the search policy enforcement module 212 via network 220 (illustrated as data path C). Any applicable search and browse policies and/or content preferences identifiable due to the identity of the user, computing device, network, user's location, and the like, the search query and/or the search results are identified. All identified search and browse policies and/or content preferences are applied to the search results and the search results and modified and/or enhanced in accordance therewith. The modified/enhanced search results are presented in association with the personal computing device 210 utilizing presentation component 222 (or an equivalent thereof). Thus, any presented search results are in compliance with all applicable search and browse policies and/or content preferences.

In other embodiments of the present invention (not shown), the search and browse policies and/or content preferences may be communicated to the search provider(s) in advance of receiving a search query and stored in association with the search provider(s) or may be communicated to the search provider(s) alongside or in conjunction with the search query. In such embodiments, the communication component (232 of FIG. 2) is further configured to communicate search and browse policies and/or content preferences to the search provider(s). If desired, the search and browse policies and/or content preferences may be applied by the search provider without additional processing by the search policy enforcement module or personal computing device such that the search results returned to the search policy enforcement module and/or personal computing device are in compliance with all applicable search and browse policies and/or content preferences. Any and all such variations, and any combination thereof, are contemplated to be within the scope of embodiments of the present invention.

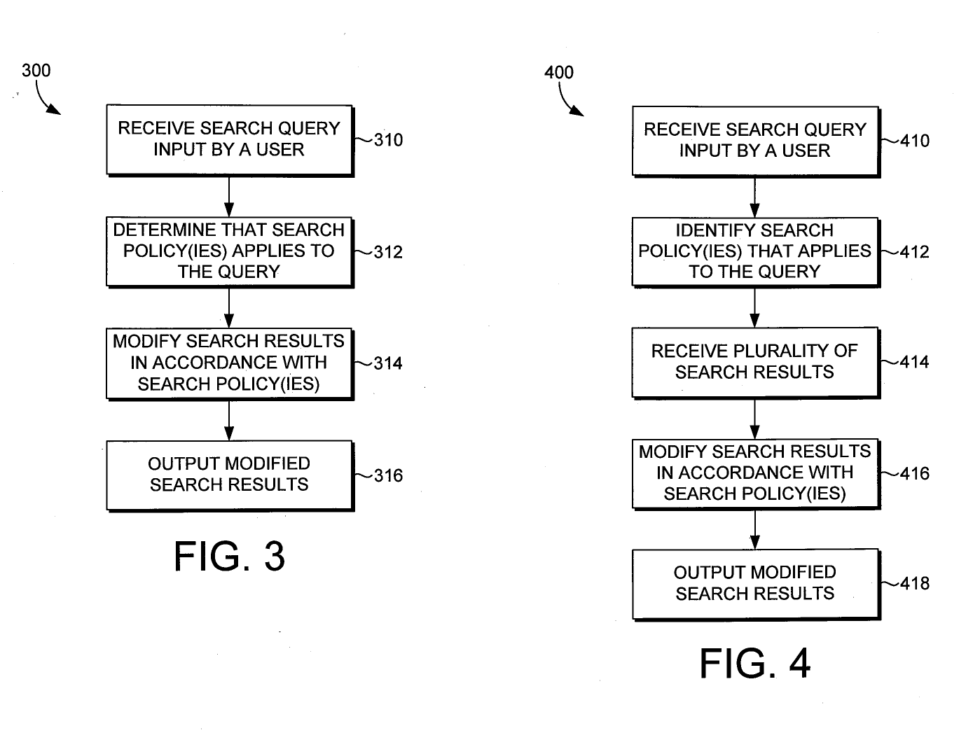

Turning now to FIG. 3, a flow diagram is provided that illustrates a method 300 for utilizing search and browse policies and/or content preferences to determine search results, in accordance with an embodiment of the present invention. As indicated at block 310, a search query input by a user is received. One or more search and browse policies and/or content preferences that apply to the received search query are identified, as indicated at block 312. As indicated at block 314, search results identified as satisfying the input search query are modified in accordance with the identified search policy(ies). Such modification may include, by way of example only, a change in the order in which search results are to be presented, omission of an identified search result, enhancement of identified search results with additional content, or the like, and may be performed by one or more of a search provider, a search policy enforcement module (stand-alone or integrated) and a personal computing device, as described herein above. The modified search results are then output (e.g., presented), as indicated at block 316.

With reference to FIG. 4, a flow diagram is provided that illustrates a method 400 for utilizing search and browse policies and/or content preferences to determine search results, in accordance with another embodiment of the present invention. As indicated at block 410, a search query input by a user is received. One or more search and browse policies and/or content preferences that apply to the received search query are identified, as indicated at block 412. As indicated at block 414, a plurality of search results satisfying the input search query received and are modified in accordance with the identified search policy(ies), as indicated at block 416. Such modification may include, by way of example only, a change in the order in which search results are to be presented, omission of an identified search result, enhancement of identified search results with additional content, or the like, and may be performed by one or more of a search provider, a search policy enforcement module (stand-alone or integrated) and a personal computing device, as described herein above. The modified search results are then output (e.g., presented), as indicated at block 418.

As can be understood, embodiments of the present invention provide systems and methods for factoring user-specific search and browse policies and content preferences into Web search results. Such search and browse policies and/or content preferences may be provided, for instance, by an employer, parent, educator, administrator, or the like, and specify to whom they apply, e.g., employees (all or a subset thereof) and/or other persons associated with the relevant entity, user groups, computing devices (or groups thereof), networks, and the like. Upon receiving a search query, it is determined whether one or more search and browse policies and/or content preferences apply to the received search query. If it is determined that one or more search and browse policies and/or content preferences apply to the received search query, at least one of the received search query and any search results determined as satisfying the search query are analyzed in accordance with the one or more applicable search and browse policies and/or content preferences. Any necessary modifications are made to the search results before the results are presented to the user. Thus, the results of the input search query that are presented to the user are in compliance with any applicable browse and search policies and/or content preferences.

The present invention has been described in relation to particular embodiments, which are intended in all respects to be illustrative rather than restrictive. Alternative embodiments will become apparent to those of ordinary skill in the art to which the present invention pertains without departing from its scope.

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

It will be understood by those of ordinary skill in the art that the order of steps shown in the method 300 of FIG. 3 and the method 400 of FIG. 4 are not meant to limit the scope of the present invention in any way and, in fact, the steps may occur in a variety of different sequences within embodiments hereof. Any and all such variations, and any combination thereof, are contemplated to be within the scope of embodiments of the present invention.

What is claimed is:

1. One or more computer-readable storage media storing computer-useable instructions that, when used by one or more computing devices, cause the one or more computing devices to perform a method for utilizing search policies to determine search results, the method comprising:
receiving a search query input by a user;
determining that at least one search policy applies to the received search query;
modifying a plurality of search results that satisfies the received search query in accordance with the at least one search policy; and
outputting the modified plurality of search results.

2. The one or more computer-readable storage media of claim 1, wherein the method further comprises determining that the user is a member of a group of users, and identifying the at least one search policy by identifying that the at least one search policy applies to each member of the group of users.

3. The one or more computer-readable storage media of claim 2, wherein identifying the at least one search policy that applies to the user comprises:
categorizing the at least one received search query; and
identifying the at least one search policy based on the search query categorization.

4. The one or more computer-readable storage media of claim 1,
wherein the at least one search policy includes at least one provision that applies to a particular category of search results,
wherein the method further comprises categorizing at least one of the plurality of search results that satisfies the received search query as a member of the particular category of search results, and
wherein modifying the plurality of search results that satisfies the received search query comprises modifying the plurality of search results in accordance with the at least one provision.

5. The one or more computer-readable storage media of claim 1, wherein modifying the plurality of search results in accordance with the at least one search policy comprises modifying a suggested presentation order of at least a portion of the plurality of search results.

6. The one or more computer-readable storage media of claim 1, wherein modifying the plurality of search results in accordance with the at least one search policy comprises enhancing the plurality of search results with additional content.

7. The one or more computer-readable storage media of claim 1,
wherein the method further comprises determining a location of the user, and
wherein modifying the plurality of search results in accordance with the at least one search policy comprises modifying the plurality of search results in accordance with the at least one search policy and the determined location of the user.

8. A search result modification system, comprising:
a computing device associated with one or more processors and one or more computer-readable storage media;
a data store coupled with the computing device; and
a search policy identification engine that receives a search query input by a user and a plurality of search results that satisfies the received search query, identifies at least one search policy associated with the received search query, modifies the plurality of search results in accordance with the at least one search policy, and outputs the modified plurality of search results for presentation.

9. The search result modification system of claim 8, wherein the search policy identification engine determines that the user is a member of a group of users and identifies the at least one search policy associated with the user by identifying at least one search policy associated with each member of the group of users.

10. The search result modification system of claim 8, wherein the search policy identification engine categorizes the search query and identifies the at least one search policy associated with the user by identifying at least one search policy associated with the user based on the search query categorization.

11. The search result modification system of claim 8, wherein the at least one search policy associated with the user includes at least one provision that applies to a particular category of search results, and wherein the search policy identification engine categorizes at least one of the plurality of search results that satisfies the received search query as a member of the particular category of search results and modifies the plurality of search results in accordance with the at least one provision.

12. The search result modification system of claim 8, wherein the search policy identification engine modifies the plurality of search results in accordance with the at least one search policy by modifying a suggested presentation order of at least a portion of the plurality of search results.

13. The search result modification system of claim 8, wherein the search policy identification engine modifies the plurality of search results in accordance with the at least one search policy by enhancing the plurality of search results with additional content.

14. The search result modification system of claim 8, wherein the search policy identification engine determines a location of the user and modifies the plurality of search results in accordance with the at least one search policy and the determined location of the user.

15. One or more computer-readable storage media storing computer-useable instructions that, when used by one or more computing devices, cause the one or more computing devices to perform a method for utilizing search policies to determine search results, the method comprising:
receiving a search query input by a user;
identifying at least one search policy that applies to the received search query;
receiving a plurality of search results that satisfy the received search query;
modifying the plurality of search results that satisfy the received search query in accordance with the at least one search policy; and
outputting the modified plurality of search results.

16. The one or more computer-readable storage media of claim 15, wherein the method further comprises determining that the user is a member of a group of users, and wherein identifying the at least one search policy that applies to the user comprises identifying at least one search policy that applies to each member of the group of users.

17. The one or more computer-readable storage media of claim 15, wherein identifying the at least one search policy that applies to the user comprises:
categorizing the at least one received search query; and
identifying the at least one search policy based on the search query categorization.

18. The one or more computer-readable storage media of claim 15,
wherein the at least one search policy that applies to the user includes at least one provision that applies to a particular category of search results,
wherein the method further comprises categorizing at least one of the plurality of received search results as a member of the particular category of search results, and
wherein modifying the plurality of search results that satisfies the received search query comprises modifying the plurality of search results based on the at least one provision.

19. The one or more computer-readable storage media of claim 15, wherein modifying the plurality of search results in accordance with the at least one search policy comprises at least one of modifying a suggested presentation order of at least a portion of the plurality of search results, or enhancing the plurality of search results with additional content.

20. The one or more computer-readable storage media of claim 15,
wherein the method further comprises determining a location of the user, and
wherein modifying the plurality of search results comprises modifying the plurality of search results in accordance with the at least one search policy and the determined location of the user.
